(19) United States
(12) Patent Application Publication
(10) Pub. No.: US 2003/0097297 A1
(43) Pub. Date: May 22, 2003

(54) Method and system for enlisting the help of other people via a communications network

(76) Inventors: Fabrice L. Cavarretta, Paris (FR); Alexandre Carpentier De Changy, London (GB)

Correspondence Address: CAVARRETTA FABRICE L, 29, RUE DU FAUBOURG NONTNARTRE, PARIS, 75009, FR

(21) Appl. No.: 09/988,435

(22) Filed: Nov. 20, 2001

(51) Int. Cl. G06F 17/60

(52) U.S. Cl. 705/14; 705/8

(57) ABSTRACT

A method and system for making inquiries to a large community via Internet. A requester at his system defines a request for an action or information, and it is propagated by electronic mails through a recursive process. On a Web page, the requester describes his request and specifies a reward for those acting or participating in finding those who acted successfully. Then the requester submits his request and provides the electronic mail addresses of the first persons to propagate to. In response to the submission, the server system generates electronic messages containing the request to the electronic mails identifiers given. The user system receiving one of the electronic message displays an HTML document proposing whether to act on the request or to propagate it to a list of his acquaintances creating a new level below him in the tree. By fulfilling successfully the request, a user may receive a reward. By propagating, the user can earn a reward if a respondent who fulfills successfully the request appears below him in the tree. The propagation may finish when the requester has found his answer or when the requester has decided to stop the propagation or when the propagation has reached a predetermined branch sub level. The server system then generates electronic messages to the requester, respondents and simple intermediaries in order to close the request and to distribute the rewards earned.

### BACKGROUND OF THE INVENTION

1. Technical Field

The present invention relates to a computer method and system for enlisting the help of other people and, more particularly, to a method and system for enlisting the help of other people in acting on a request over the Internet as well as managing a system of rewards in return for assistance.

2. Background of the Invention

The Internet comprises a vast number of computers and computer networks that are interconnected through communication links. The interconnected computers exchange information using various services, such as electronic mail, Gopher, and the World Wide Web (“WWW”). The electronic mail allows information transfers between two or more systems. The WWW service allows a server computer system (i.e., Web server or Web site) to send graphical Web pages of information to a remote client computer system. The remote client computer system can then display the Web pages. Each resource (e.g., computer or Web page) of the WWW is uniquely identifiable by a Uniform Resource Locator (“URL”). To view a specific Web page, a client computer system specifies the URL for that Web page in a request (e.g., a Hypertext Transfer Protocol (“HTTP”) request). The request is forwarded to the Web server that supports that Web page. When that Web server receives the request, it sends that Web page to the client computer system. When the client computer system receives that Web page, it typically displays the Web page using a browser. A browser is a special-purpose application program that effects the requesting of Web pages and the displaying of Web pages.

Currently, Web pages are typically defined using Hypertext Markup Language (“HTML”). HTML provides a standard set of tags that define how a Web page is to be displayed. When a user indicates to the browser to display a Web page, the browser sends a request to the server computer system to transfer to the client computer system an HTML document that defines the Web page. When the requested HTML document is received by the client computer system, the browser displays the Web page as defined by the HTML document. The HTML document contains various tags that control the displaying of text, graphics, controls, and other features. The HTML document may contain URLs of other Web pages available on that server computer system or other server computer systems.

The World Wide Web is especially conducive to communicating and coordinating with other people. Many Web servers have been developed through which individuals can post a request for help (e.g., in finding an apartment, finding someone to fill a job, etc.). A server computer may function as a listing service, providing information similar to what can be found in a newspaper classifieds section. A user who wants to find something (e.g., an apartment) can browse the available listings that have been provided by others. If something matches what the user is looking for, the user generally contacts the lister directly.

An alternative way for an individual to request or find something using the Internet involves the use of Email. In this scenario, the user might describe his/her request in an email (e.g., “does anyone know of apartments for rent in the XYZ neighborhood”) and send it to a few friends. The friends can either respond to the email or forward it to their friends. By this process, the request propagates through a network of people. Eventually, someone may have what the user is looking for, and that person can contact directly the original requester in order to arrange a transaction (e.g., come by and see the apartment). The advantage of this method over the former described above is that it is requester-initiated. That is, the requester can initiate a search for something before it has been listed with a listing service. This system works better in competitive markets (e.g., when housing is in demand), when the item sought is too unusual or particular to be listed somewhere, or when the item's owner is not seeking to sell it, but is open to entertaining offers.

### SUMMARY OF THE INVENTION

An embodiment of the present invention provides a method and system to enlist the help of other people in acting on a request. It also provides a mechanism for managing reward strategies in order to motivate individuals who receive the request to enlist others in the effort to resolve it. Thus the invention enables entire communities of individuals to be enlisted in the service of solving a problem (e.g., finding an apartment).

In order to use the system, the requester, using a web browser, contacts the Web server managing the request and propagation database. First, the requester defines a request for an action or for information. Then, the requester states the reward to be split between the respondent who fulfills successfully his request and the intermediaries who help him to find that respondent by propagating his request to others. Finally, the requester enters the individuals he wants the request to be sent to initially, e.g., via email.

When individuals receive a copy of the request, they are offered the following options: they can attempt to fulfill the request or they can propagate it to additional individuals. For each option, they can potentially earn the reward or part of it in accordance with reward allocation scheme. If an individual elects to propagate, he becomes a propagator and may earn a reward if he is later determined to have connected the requester to the respondent who fulfilled successfully by forwarding the request to new people. The propagation continues to additional levels until an individual provides a successful answer to the request or the original requester closes the request. When an individual fulfills a request by replying successfully to it, that individual may earn the fulfilling reward and all his relationships above him in the tree earn their propagation reward. When the search is concluded, the system automatically administrates the process of dividing up the reward among the respondent and the various intermediaries whose propagation led to the respondent. They constitute the winning branch. The results of this process are communicated to the individuals of that winning branch via messages generated by the system.

### BRIEF DESCRIPTION OF THE DRAWINGS

FIGS. 1A-1C illustrate the creation of a request in one embodiment of the present invention.

FIGS. 2A-2C illustrate the propagation function in one embodiment of the present invention.

FIGS. 3A-3B are block diagrams illustrating an embodiment of the present invention and the reward schemes.

FIG. 4 is a block diagram illustrating the invention mechanism in one embodiment.

### DETAILED DESCRIPTION OF THE INVENTION

The present invention provides a method and system for managing the propagation of requests among individuals connected to the Internet. The propagation management system of the present invention works by tracking the dissemination of the request and recording the potential answers. The propagation system allows the user to make targeted, subtle, and open-ended inquiries by leveraging human intuition and resourcefulness rather than relying on mechanical computer search engines. In one embodiment, the user needs to create an account in order to post request and become a “requester”. Once registered, the requester defines the characteristics of his request by filling out a form sent by the server system and displayed on his web browser. In this web page, the requester must specify a reward to be divided in response to the answer to his request and a reward for the intermediaries who led to the successful response. Then, in a second web form displayed on his web browser, the requester enters the electronic mail addresses he wants the request to be sent to. By confirming the list, the requester instructs the server system to generate electronic mail messages containing the information given by the requester and send them to the addresses given. This propagation constitutes the first level of a tree, with each electronic mail recipient becoming one of its branches. When an individual (a “receiver”) receives an electronic mail, he is offered two choices. The receiver can either act on the request or propagate the request to a new list of electronic mail recipients. In both cases, his acting may earn the receiver a reward if he successfully fulfills the request or if a respondent discovered as a result of the recipient's propagation successfully fulfills the request. By propagating, the receiver becomes a “propagator”, and a node along with its propagations constitute the second level of the tree and its branches. The tree can grow indefinitely, unless a limit was specified when creating the request. The request can also be stopped in different ways subject to the desire of the requester. Thus, once a given request is generated by the server system, the list of electronic mail addresses given by the requester can develop into a large community. Each Internet user is a potential target and can offer his proposed answer.

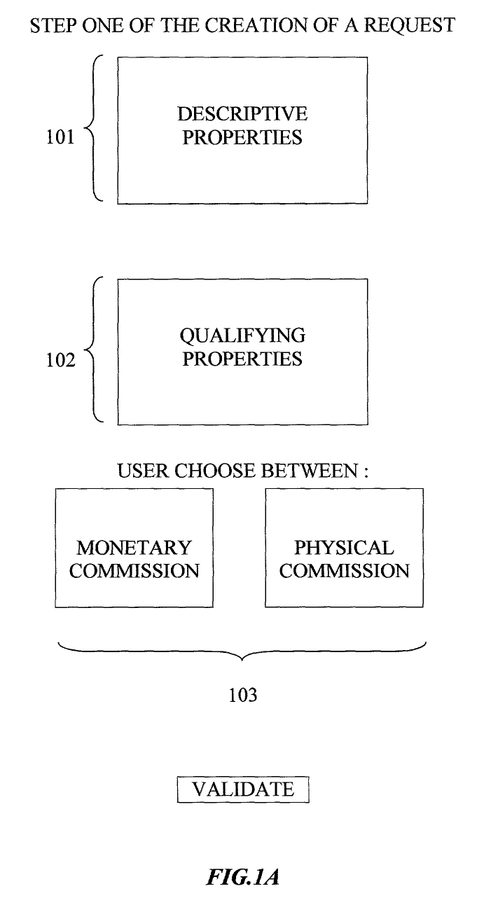

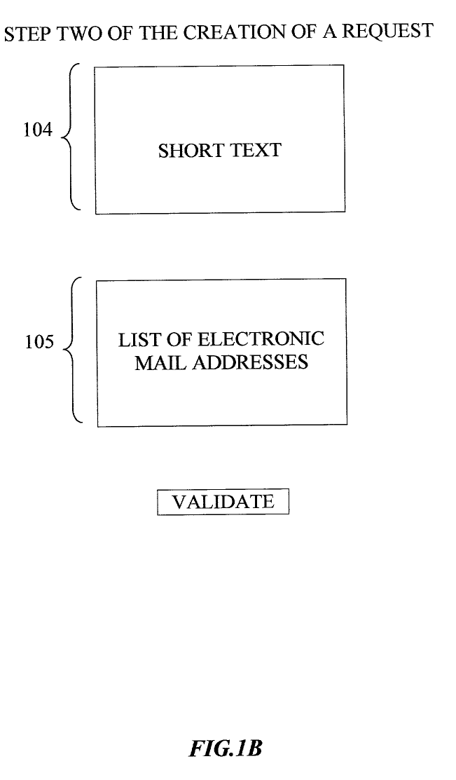

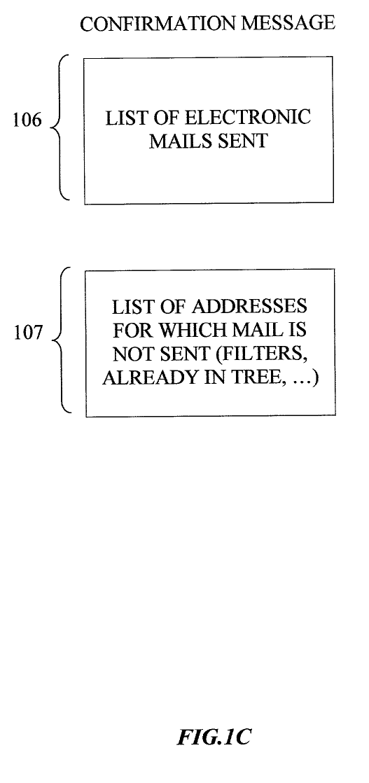

FIGS. 1A-1C illustrate the creation of a request in one embodiment of the present invention. FIG. 1A illustrates the display of a web page including fields of information the requester will have to fill out in order to create his request. This example web page contains descriptive properties of the request section 101, qualifying properties section 102 and the method of reward section 103. One familiar with these types of systems will appreciate that these various sections can be rearranged or adapted in various ways. In terms of descriptive properties, the requester must specify the title and a short description of his request. Those elements will be displayed in the electronic mail generated for propagation. The qualifying properties identify the nature of the request and include for example the aim of request, its category, its number of subdivisions in the tree, etc (e.g., Type: Push; Category: Jobs; Geography: USA California San Francisco Bay area; etc). At the time of the creation of the request, the requester also sets the reward scheme to be applied to the individuals of the winning branch. The reward scheme can be of “automatic” type; where the requester sets the total amount and the currency of the reward which the server system will use to compute automatically the reward at each level. Likewise, the reward scheme can be of “predetermined” type; the requester defines both the reward for the person fulfilling successfully the request, and a descriptive list of rewards for the simple intermediaries in the winning branch.

Once the requester has filled out these three sections, he confirms the information. In confirming the information, the requester system instructs the server system to create a request specific to the information given. The requester must specify the electronic mail addresses he wants his request to be sent to. FIG. 1B illustrates the appearance of an example web page including two empty fields. The requester will have to specify a brief message for the receiver section 104 and a list of electronic mail addresses section 105. This brief message is not a second description of the request but a general piece of freeform text directed at the receiver (e.g., “thanks for propagating this request to your friends. John Doe”). Each individual in the list of addresses will receive the request in electronic mail format. The receivers will become nodes of the first level in the tree and will have the opportunity to propagate the request. Expert users will appreciate that the list can be saved in an address book linked to the requester so that each time he uses the service, he will be able to refer to this address book and spread his request faster. When the requester confirms his choices, instructs the server system to propagate the request early created to the list of addresses. After performing this task, the server system will send to the requester system a Web page that confirms the dispatch action. FIG. 1C illustrates the display of a Web page confirming propagations. The confirmation Web page contains the list of electronic mail addresses by the requester typed on the Web page requiring the electronic mail addresses section 106 (i.e., FIG. 1B). Negative filters can restrict the list if some users have configured their system in order not to receive request of a specific category or from the entire service. In that case, the restricted addresses of the list will appear in a specific field section 107. Inversely, users can set positive filters. In that case, they will receive request even if he's not in a list. In fact, they will be automatically included at level 1 of public requests that fit certain criteria (e.g., subject of the request, geography of the request).

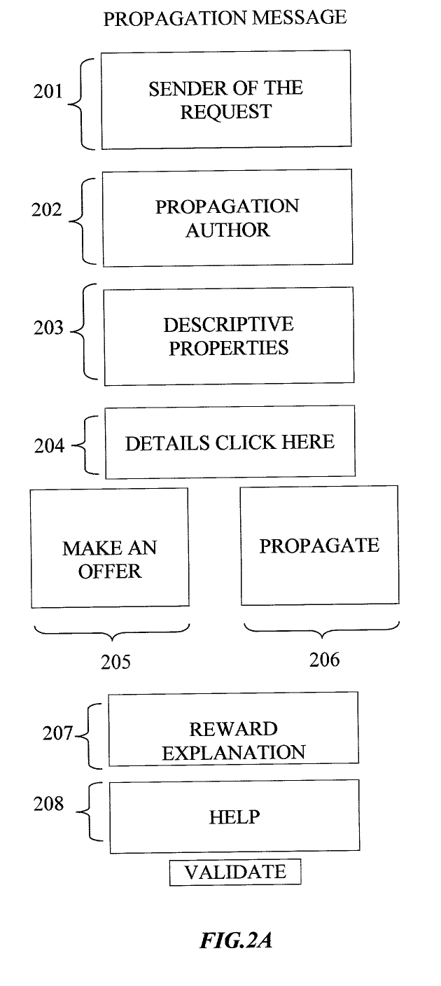

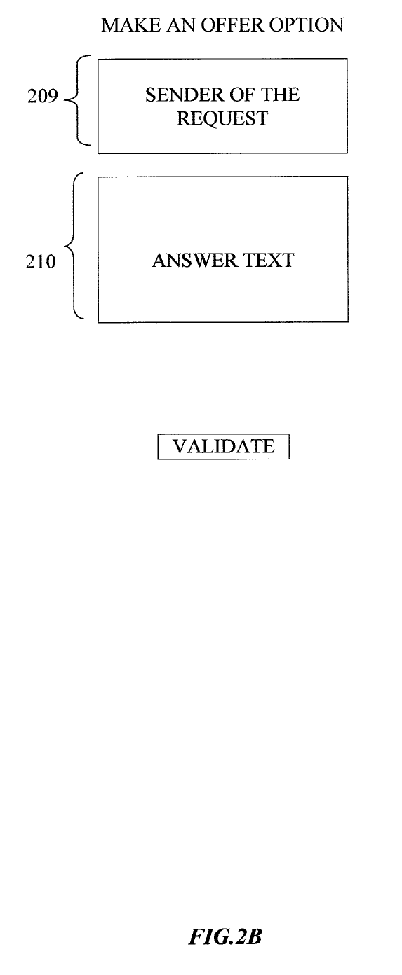

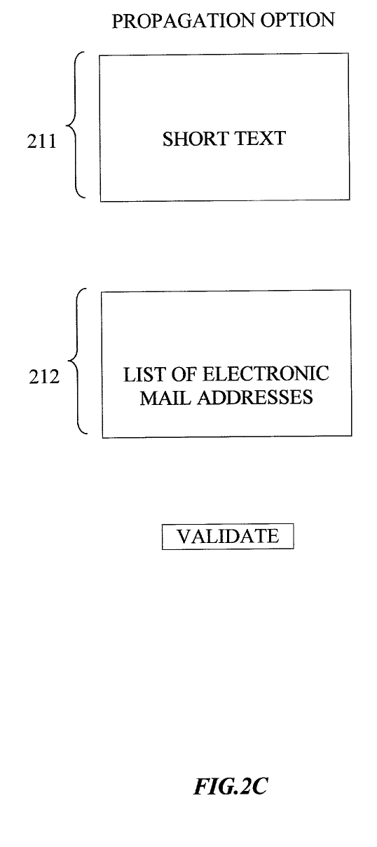

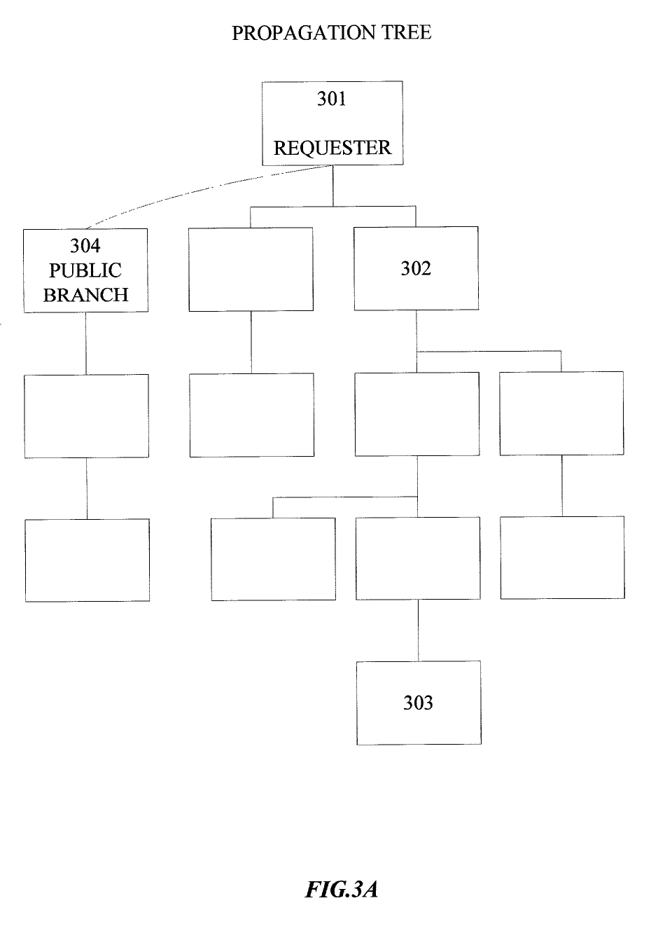

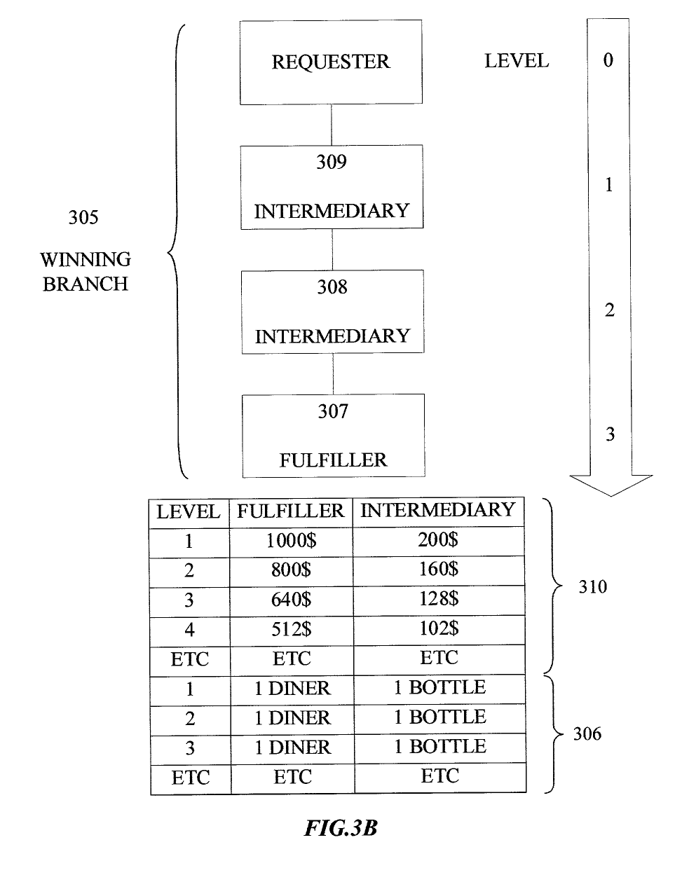

FIGS. 2A-2C illustrate the propagation function in one embodiment of the present invention. FIG. 2A illustrates the display of a request when received by the individual. It appears in a message describing the content of the request and the ways to participate to his success. The FIG. 2A example contains on its top the name of the expeditor section 201. It doesn't mean that the expeditor is the requester. It might be a propagator. Then the example displays the name of the requester section 202. However, the service allows the requester to create an anonymous request. In that case, his name and electronic mail address won't appear in this section but the word “anonymous” instead. If the request is anonymous, the identity of the requester will be divulged only when the requester decides to do so. The page also provides parts of the information given by the requester for the description of his request section 203. It includes the descriptive properties quoted in FIG. 1A and the brief message quoted in FIG. 1B. Furthermore, if the receiver wants more details about the request, he can click on the link just above the description section 204. If he clicks, a new message will appear with the full description given by the requester when he'd filled out his request. The main part of the propagation message is the two options proposed to the receiver. First, the receiver can act on the request. In that case, the receiver will click on the link named “make an offer” section 206. Second, the receiver can propagate the request to a list of electronic mail addresses he will suggest. In that case, he will click on the link named “propagate” section 205. Section 207 displays the reward the individual may earn if he successfully fulfills the request or if he is on the winning branch as a propagator, that is to say that the answer of the request has been found somewhere below him in the propagation tree. The evaluation is made by the server system (i.e., FIG. 3B). Moreover, if the receiver wants details about the working of the system, he can click on the link “help” section so that a message will displays the information section 208.

Once the receiver selects “make an offer” option by clicking on the link in the message, his system would open a Web page. FIG. 2B illustrates the display of the new Web page for making an offer. The replier is pre-determined by his electronic mail address that is displayed in the form field section 209. The replier can change that electronic mail address if he wishes so, but in that case, he would be subjected to check electronic mails to that address. If he does not change that electronic mail address, the system does assume he is the proper user. The system server bases such recognition on the fact that when the user clicks on a button, the client system sends to the server a unique ID imbedded in the message that link such action to that specific electronic mail address. Such method not only enables to guess the replier address, but also to assume that he owns such address since he has access to the electronic mail sent to it. The Web page also contains a single section the replier has to fill in, section 210. He types a text constituting his submission of act as fulfilling the request. By accepting or refusing that submission, the requester can accept or reject the act as fulfilling the request. By accepting, the request is successfully fulfilled. Moreover, the acceptance leads to a process of rewarding the winners and if necessary to close the request whereas the rejection has no effect for the propagation process but only declines the submission.

When the individual selects “propagation” option by clicking on the link, a new Web page appears. FIG. 2C illustrates the display of the Web page for propagation. It contains the same sections as FIG. 1B. The same method as “make an offer” enables the system to automatically display the assumed electronic mail address of the propagator and trust it if he does not change it. The propagator will have to specify a brief message for the receivers section 211 and a list of electronic mail addresses section 212. As for the request, the propagation mail contains a brief message. It isn't a redundant description of the request but a general text with a free content aimed at the receiver (e.g., “thanks for propagating this request to your friends. John Doe”). Each individual in the list of addresses will receive the same electronic mail. The receivers will become nodes of the second degree in the tree and will have the possibility to propagate again the request. Expert users will noticed that a limit could be fixed for the propagation depth since the server controls process. At the time of the creation of the request, the requester determines the maximum degree. The maximum degree must be greater than 1 degree in order to be differentiated from basic electronic mail. When validating, an electronic mail is sent to the propagator who propagated as FIG. 2C in order to precise the identifiers that received or not the request because of negative filters, or being already in the tree.

The requester can also determine, at the creation of his request, whether his request is public or not. If it is public, any internet user can view it, and, if he is not already in the tree, create his own branch by asking in the web site to be attached to the tree. This user becomes a propagator and starts at level one. This user can also fulfill the request. If it is private, only people directly receiving the propagation can participate in the tree system.

FIGS. 3A-3B are block diagrams illustrating an embodiment of the present invention and the reward principles. FIG. 3A constitutes an embodiment supporting the propagation method through the Internet. The propagation system can be depicted as a tree. At the top of the tree, the requester 301 creates a request and decides to propagate it to a list of electronic mails addresses. Since the receivers have the option of either propagating the request to individuals or making an offer, the request can reach a depth of many levels. Thanks to a propagator in the first level 302, an individual in the fourth level 303 received the request. In addition, if the requester elected to mark the request public, any individual can be added to the tree at the first level 304 and can propagate the request (“propagate”) or act on the request (“make an offer”). Most of the time, the propagator will spread the request with the goal of helping the requester or his friends. However, an additional motivation is the reward offered by the requester, especially farther down the tree.

Once the requester receives a submission claiming to fulfill the request, he may accept it or reject it. If he accepts it, a winning branch is identified. Each individual that leads to the successful respondent is part of the winning branch. In that case, the server system evaluates, according to a reward scheme, the way the reward will be distributed in order to remunerate the individuals of the winning branch (i.e., FIG. 3B). Then the server system generates electronic mails to the individuals of the winning branch. If the requester rejects the submission of act as fulfilling the request, the replier is informed and nothing else happens. The requester can close whenever he wants. It can be before any winner has been found, after the first winner, or he can even find many winners before finally deciding to close. The distribution of the reward depends on the scheme chosen by the requester at the creation of the request: either a “predetermined” reward or an “automatic” one. One skilled in the art would appreciate that those two schemes constitute a preview of the reward, that is that before knowing who won, the potential gain as respondent or as simple intermediary can be stated for each participant. Section 305 represents a winning branch. There are three levels.

For a “predetermined” reward, section 306 illustrates the result. The principle is that the requester has determined, at the creation of the request, the reward for each individual of the winning branch. In case the respondent successfully fulfills the request, he would receive a specific reward and each simple intermediary of the winning branch would also earn a determined reward. In this case, the respondent 307 would earn a diner and each simple intermediary 308 and 309 would earn a bottle of wine.

For an “automatic” reward, section 310 illustrates the result. The key point is that the requester proposes, when creating the request, a sum available to the whole winning branch that will be automatically computed by the server system for each level of the tree. In fact, the “automatic” reward is split between the respondent who fulfilled successfully the request and the simple intermediaries using a ratio fixed by the server (e.g., Ratio R=20%). The server system determines for each node of the branch its potential winning status as simple intermediary or as respondent who fulfilled successfully the request. The server system begins at level one. In case the node were the respondent, he would earn the full available sum. In case the node is a simple intermediary, he would earn only R of the reward. The rest of it, 1-R, would be available to the next level of the branch. The server system then follows the branch. At level two, in case the node were the respondent, he would earn the sum available at that level. If the node were a simple intermediary, he would earn R of the sum available at that level and the other part would be available to the next level of the branch. The process continues as long as there is propagation. In this example, if the reward is $1000 and the ratio R=20%, 309 would earn $200, 308 would earn $160 (20% of $800) and 307 would receive the rest of the sum:$640.

When the requester closes his request and decides who did fulfill his request, the system then computes the definite reward along the winning branch. The server system generates electronic mails to every individual in the tree in order to warn them of their reward. All the other members of the tree will receive an electronic mail to inform them they have lost.

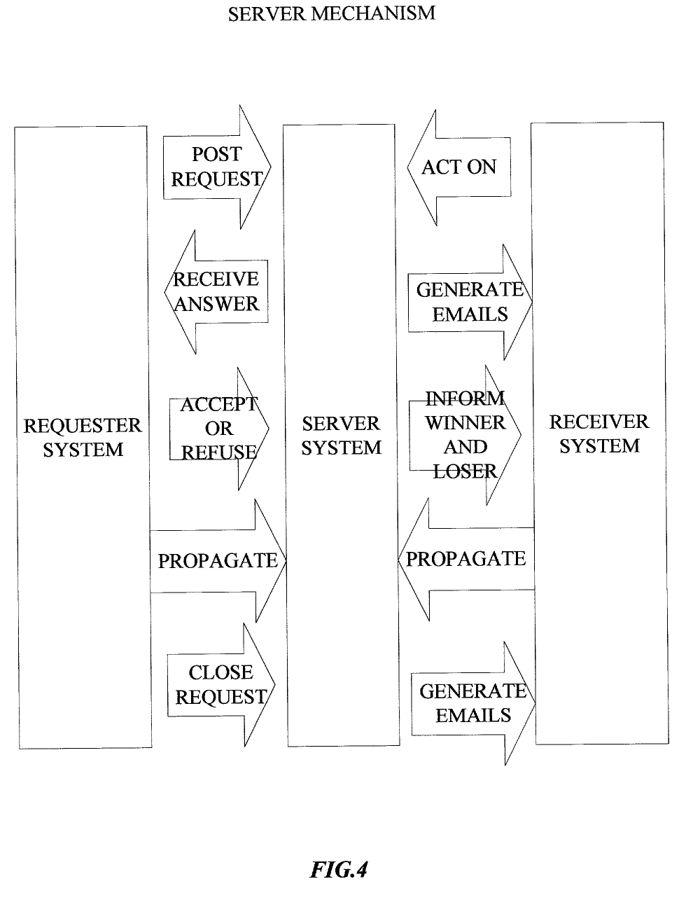

FIG. 4 is a block diagram illustrating the invention mechanism in one embodiment. It contains different elements interacting together: a requester system, a server system and a receiver system (either a respondent or a simple intermediary). The servers system constitutes the link between the requester and the receiver. First, the server system has a passive role: it receives instructions and executes them. It generates electronic mails and dispatches them to the addresses given but does not check their contents. In addition, the server system distributes the reward. To perform this other function, the server system follows a set of pre-defined rules using the value provided by the requester so that it performs the order in a passive way as well. The goal of the server system is to transport information automatically, without requiring intervention of the authors. Both requester and receiver constitute the intelligent component of the process. They interact with each other. They need to define the request, propagate it, respond to it, etc. They send and receive electronic mails thanks to the server system. The scope of the present invention is defined by the claims that follow.

We claim:

1. A method for making inquiries:
Under control of a request module of a user system,
Displaying fields for creating a request for an action, and for proposing its reward; and
In response to the fields fulfilled, sending the order to a server system to propagate the request to a list of individuals proposed by the requester;
Under control of the propagation module of the server system,
Receiving the information about the request to be created,
Generating messages displaying the request to the list of individuals; and
Under control of the client system of the receiver,
Proposing the choices of whether to propagate the request to a new list of individuals that the receiver proposes with the promise of a potential reward or to act on the request with the promise of a potential reward; and
In response to choosing the propagation option, sending an order to the server system to forward the request to a new individual list, following the propagation module;
Keep on propagating the request through such like a tree process,
In response to choosing the “act on” option, sending an order to take into account the action of the user;
Under control of the user system,
Displaying the option to the user whether to accept or to reject the act as fulfilling his request,
In response to an acceptance, sending the order to reward the replier and those who propagated the request through the branch of the replier.

2. The method of claim 1 wherein the propagation is a viral process.

3. The method of claim 1 wherein the act the user can perform on the request can be sending information to the requester about an object, a person difficult to find or any question difficult to answer (e.g., collectible, lost and found, missing, etc).

4. The method of claim 1 wherein the act the user can perform on the request can be about any type of transaction the requester wishes to do, without any constraints on its type (e.g., providing lead for new client, for new investors, new partner, new employer, etc).

5. The method of claim 1 wherein the act the user can perform on the request can be performing a commercial or non-commercial act with the requester (e.g., purchase, registration, etc).

6. The method of claim 1 wherein the act the user can perform on the request can be performing an act to some third party (e.g., communicate with them, send a petition, etc).

7. The method of claim 1 wherein the display of identity of the user that performs the request can be anonymous.

8. The method of claim 1 wherein the request can be public so that visitors to the site can view the request, be registered at level 1, propagate or act on the request.

9. The method of claim 1 wherein the user that performs the request chooses the reward scheme stating the reward for fulfilling the request and the reward for being a simple intermediary.

10. The method of claim 1 wherein the reward scheme can be of type “automatic” or “predetermined”.

11. The method of claim 1 wherein the split for the “automatic” scheme is computed, at each level, using a ratio R fixed by the system for all requests and for all levels (e.g., R=20% kept for the simple intermediary and 80% available for the level below).

12. The method of claim 1 wherein the split for the “automatic” scheme is computed using a ratio fixed by each requester for all levels.

13. The method of claim 1 wherein the split for the “automatic” scheme is decided at each level using a ratio fixed by each propagator for his level.

14. The method of claim 1 wherein the split for “predetermined” scheme defines both the reward for the person successfully acting on the request, and a descriptive list of rewards for the simple intermediaries in the winning branch.

15. The method of claim 1 wherein the user that performs the request can choose whether to include or to exclude the submitter that proposed a winning solution from the sharing out and give the fulfilling reward to the level just above (e.g., in case he is the buyer in a sell request).

16. The method of claim 1 wherein the two reward schemes are displayed as preview in the web pages and messages, that is that before knowing who won, the potential gain as respondent or as simple intermediary can be stated for each participant.

17. The method of claim 1 wherein a receiver of the request does not need to identify himself when propagating because being automatically identified by clicking in an electronic message that contains an unique identifier under a rich link.

18. The method of claim 1 wherein the individual identifier is an electronic identifier (e.g., login, phone number, electronic mail address, etc).

19. The method of claim 1 wherein the individual identifier is a postal address.

20. An receiver system for propagating or acting to a request comprising:
A display component for displaying the message generated by the server system;
A propagation component that in response to a new list of individuals, sends an order to the server system to forward the message to the list of individuals;
A reply component that in response to a reply to the request to an action, sends an order to the server system to warn the requester about the answer.

21. The receiver system of claim 20 wherein the display component is a browser.

22. The receiver system of claim 20 wherein the display component is a mail reader.

23. The receiver system of claim 20 wherein the display component is a Personal Digital Assistant (PDA).

24. The receiver system of claim 20 wherein the display component is a telephone.

25. The receiver system of claim 20 wherein users can set positive filters to be automatically included at level 1 of public request that fit certain criteria.

26. A method for making inquiries using a requester system, the method comprising:
Displaying fields for creating a request for an action, proposing its reward and the list of individuals to propagate to; and
In response to the information being given, sending to a server system an order to propagate a message including the information the user that performs the request filled in,
Whereby the user that performs the request expects, thanks to the propagation system, a reply to his request for an action collected by the server.

27. The method of claim 26 wherein the user system and the server system communicate via the Internet.

28. The method of claim 26 wherein the displaying uses HTML codes provided by the server system.

29. The method of claim 26 wherein the displaying uses XML codes provided by the server system.

30. The method of claim 26 wherein the displaying uses Infrared codes provided by the server system.

31. The method of claim 26 wherein the propagation is electronic mails system.

32. The method of claim 26 wherein the propagation uses cellular (e.g., sms) message system.

33. The method of claim 26 wherein the displaying uses telephone (tone or pulse) system.

34. The method of claim 26 wherein the displaying uses digital system of transfer of information.

35. The method of claim 26 wherein the displaying uses analogical system of transfer of information.

36. The method of claim 26 wherein the propagation uses electronic system of transfer of information.
